(19) United States
(12) Patent Application Publication
(10) Pub. No.: US 2022/0302444 A1
(43) Pub. Date: Sep. 22, 2022

(54) POSITIVE ELECTRODE AND NONAQUEOUS ELECTROLYTE SECONDARY BATTERY

(71) Applicant: Prime Planet Energy & Solutions, Inc., Tokyo (JP)

(72) Inventors: Mamoru KURAMOTO, Kobe-shi (JP); Hidekazu HIRATSUKA, Osaka (JP); Masumi TERAUCHI, Koriyama-shi (JP); Hiroki WATANABE, Akashi-shi (JP)

(21) Appl. No.: 17/696,870

(22) Filed: Mar. 17, 2022

(30) Foreign Application Priority Data
Mar. 18, 2021 (JP) 2021-044450

(51) Int. Cl. H01M 4/36

(52) U.S. Cl. CPC H01M 4/366; H01M 2004/028

(57) ABSTRACT

A positive electrode is used for a nonaqueous electrolyte secondary battery. The positive electrode includes a positive electrode substrate and a positive electrode active material layer. The positive electrode active material layer is disposed on a surface of the positive electrode substrate. The positive electrode active material layer includes a first layer and a second layer. The second layer is disposed between the positive electrode substrate and the first layer. The first layer includes a first positive electrode active material. The first positive electrode active material includes first aggregated particles. The second layer includes a second positive electrode active material. The second positive electrode active material includes second aggregated particles and single-particles. Each of the first aggregated particles and the second aggregated particles is formed by aggregation of 50 or more primary particles. The single-particles have an arithmetic mean diameter larger than the primary particles.

This nonprovisional application is based on Japanese Patent Application No. 2021-044450 filed on Mar. 18, 2021, with the Japan Patent Office, the entire contents of which are hereby incorporated by reference.

### BACKGROUND OF THE INVENTION

### Field of the Invention

The present technology relates to a positive electrode and a nonaqueous electrolyte secondary battery.

### Description of the Background Art

Japanese Patent Laying-Open No. 2020-087879 discloses a lithium metal composite oxide powder composed of: secondary particles formed by aggregation of primary particles; and single-particles.

### SUMMARY OF THE INVENTION

In general, a positive electrode of a nonaqueous electrolyte secondary battery (hereinafter, also simply referred to as “battery”) includes a positive electrode substrate and a positive electrode active material layer. The positive electrode active material layer is formed on a surface of the positive electrode substrate.

The positive electrode active material layer includes a positive electrode active material. In many cases, the positive electrode active material is aggregated particles. Each of the aggregated particles is a secondary particle obtained by aggregation of a multiplicity of primary particles.

It has been proposed to mix single-particles with the aggregated particles. The single-particles are primary particles grown to be comparatively large. The single-particles can be present independently of the aggregated particles. The single-particles are excellent in packing characteristic. By mixing the single-particles with the aggregated particles, the packing characteristic of the positive electrode active material layer can be improved. The improved packing characteristic of the positive electrode active material layer can lead to an improved energy density of the battery.

However, the single-particles tend to have higher resistivity than the aggregated particles. When the aggregated particles are mixed with the single-particles, the resistivity of the positive electrode active material layer tends to be increased. The increased resistivity of the positive electrode active material layer may lead to, for example, a decreased input/output characteristic of the battery.

An object of the present technology is to ensure both packing characteristic and resistivity of a positive electrode active material layer.

Hereinafter, configurations, functions, and effects of the present technology will be described. However, a mechanism of function in the present specification includes presumption. The mechanism of function does not limit the scope of the present technology.

[1] A positive electrode is used for a nonaqueous electrolyte secondary battery. The positive electrode includes a positive electrode substrate and a positive electrode active material layer. The positive electrode active material layer is disposed on a surface of the positive electrode substrate. The positive electrode active material layer includes a first layer and a second layer. The second layer is disposed between the positive electrode substrate and the first layer. The first layer includes a first positive electrode active material. The first positive electrode active material includes first aggregated particles. The second layer includes a second positive electrode active material. The second positive electrode active material includes second aggregated particles and single-particles. Each of the first aggregated particles and the second aggregated particles is formed by aggregation of 50 or more primary particles. The single-particles have an arithmetic mean diameter larger than an arithmetic mean diameter of the primary particles.

Hereinafter, in the present specification, the first aggregated particles and the second aggregated particles may be collectively referred to as “aggregated particles”. It should be noted that the second aggregated particles may be the same as or different from the first aggregated particles.

The positive electrode active material layer of the present technology has a multilayer structure. That is, the positive electrode active material layer includes the first layer (upper layer) and the second layer (lower layer). The first layer (upper layer) is disposed on the surface side of the positive electrode active material layer with respect to the second layer (lower layer). According to a new finding in the present technology, the resistivity of whole of the positive electrode active material layer tends to be greatly affected by the resistivity in the vicinity of the surface layer of the positive electrode active material layer. The first layer (upper layer) is mainly composed of the aggregated particles. Each of the aggregated particles can have a relatively low resistivity. Since the upper layer is mainly composed of the aggregated particles, an increase in resistivity due to the mixing of the single-particles can be reduced.

The second layer (lower layer) is composed of the mixture of the aggregated particles and the single-particles. By mixing the single-particles in the lower layer, an increase in resistivity can be reduced and the packing characteristic of the positive electrode active material layer can be improved.

[2] For example, the first aggregated particles may have an arithmetic mean diameter larger than the arithmetic mean diameter of the single-particles, and the second aggregated particles may have an arithmetic mean diameter larger than the arithmetic mean diameter of the single-particles.

Since the aggregated particles are larger than the single-particles, it is expected to improve the packing characteristic or the like, for example.

[3] For example, a relation of the following formula (I) may be satisfied:

0.2≤T1/(T1+T2)≤0.5 (I).

In the formula (I), “T1” represents a thickness of the first layer, and “T2” represents a thickness of the second layer.

When the relation of the formula (I) is satisfied, it is expected to improve balance between the packing characteristic and the resistivity, for example. Hereinafter, “T1/(T1+T2)” is also referred to as a “thickness ratio” in the present specification.

[4] A nonaqueous electrolyte secondary battery includes the positive electrode according to any one of [1] to [3].

In the battery of the present technology, it is expected to ensure both energy density and input/output characteristic, for example.

The foregoing and other objects, features, aspects and advantages of the present technology will become more apparent from the following detailed description of the present technology when taken in conjunction with the accompanying drawings.

### BRIEF DESCRIPTION OF THE DRAWINGS

FIG. 1 is a schematic diagram showing an exemplary configuration of a nonaqueous electrolyte secondary battery in the present embodiment.

FIG. 2 is a schematic diagram showing an exemplary configuration of an electrode assembly in the present embodiment.

FIG. 3 is a schematic cross sectional view showing an exemplary configuration of a positive electrode in the present embodiment.

FIG. 4 is a conceptual diagram of aggregated particles and single-particles.

### DESCRIPTION OF THE PREFERRED EMBODIMENTS

Hereinafter, an embodiment (also referred to as “the present embodiment” in the present specification) of the present technology will be described. However, the scope of the present technology is not restricted by the following description. For example, a description regarding functions and effects in the present specification does not limit the scope of the present technology to the scope in which all the functions and effects are exhibited.

### Definitions of Terms, Etc

In the present specification, expressions such as “comprise”, “include”, and “have” as well as their variants (such as “be composed of”, “encompass”, “involve”, “contain”, “carry”, “support”, and “hold”) are open-end expressions. Each of the open-end expressions may or may not further include additional element(s) in addition to essential element(s). The expression “consist of” is a closed expression. The expression “consist essentially of” is a semi-closed expression. The semi-closed expression may further include additional element(s) in addition to essential element(s) as long as the object of the present technology is not compromised. For example, a normally conceivable element (such as an inevitable impurity) in the field to which the present technology belongs may be included as an additional element.

In the present specification, each of the words “may” and “can” is used in a permissible sense, i.e., “have a possibility to do”, rather than in a mandatory sense, i.e., “must do”.

In the present specification, elements represented by singular forms (“a”, “an”, and “the”) may include elements represented by plural forms as well, unless otherwise stated particularly. For example, a “particle” can include not only “one particle” but also a “collection of particles (powdery body, powder, particle group)”.

In the present specification, a numerical range such as “10 μm to 20 μm” and “10 to 20 μm” includes the lower and upper limit values unless otherwise stated particularly. That is, each of the expressions “10 μm to 20 μm” and “10 to 20 μm” represents a numerical range of “more than or equal to 10 μm and less than or equal to 20 μm”. Further, numerical values freely selected from the numerical range may be employed as new lower and upper limit values. For example, a new numerical range may be set by freely combining a numerical value described in the numerical range with a numerical value described in another portion or table of the present specification, a figure, or the like.

In the present specification, all the numerical values are modified by the term “about”. The term “about” can mean, for example, +5%, +3%, +1%, or the like. All the numerical values are approximate values that can be changed depending on a manner of use of the present technology. All the numerical values are indicated as significant figures. Each of all the measurement values or the like can be rounded off in consideration of the number of digits of each significant figure. Each of all the numerical values may include an error resulting from a detection limit or the like.

In the present specification, when a compound is expressed by a stoichiometric composition formula such as “LiCoO₂”, the stoichiometric composition formula is merely a representative example. The composition ratio may be non-stoichiometric. For example, when lithium cobaltate is expressed as “LiCoO₂”, lithium cobaltate is not limited to the composition ratio of “Li/Co/O=1/1/2”, and can include Li, Co and O in any composition ratio, unless otherwise stated particularly. Further, doping or substitution with a small amount of element can be permitted.

Geometric terms in the present specification (for example, the terms such as “parallel” and “perpendicular”) should not be interpreted in a strict sense. For example, the term “parallel” may be deviated to some extent from the strict definition of the term “parallel”. The geometric terms in the present specification can include, for example, a tolerance, an error, and the like in terms of design, operation, manufacturing, and the like. A dimensional relation in each of the figures may not coincide with an actual dimensional relation. In order to facilitate understanding of the present technology, the dimensional relation (length, width, thickness, or the like) in each figure may be changed. Further, part of configurations may be omitted.

The “arithmetic mean diameter” in the present specification is measured in a cross sectional SEM (scanning electron microscope) image of the positive electrode active material layer. The cross sectional SEM image is obtained in a cross section parallel to the thickness direction of the positive electrode active material layer. Targets to be measured are the aggregated particles, the primary particles, or the single-particles. A magnification for observation can be appropriately adjusted in accordance with a target to be measured. For example, when the primary particles are the target to be measured, the magnification for observation can be 10000× to 30000×. For example, when the aggregated particles or the single-particles are the target to be measured, the magnification for observation can be 100× to 5000×. The diameter of each of the targets to be measured represents a distance between two points separated the farthest from each other on the contour line of the target to be measured. An arithmetic mean of 100 or more diameters is regarded as the arithmetic mean diameter.

<Nonaqueous Electrolyte Secondary Battery>

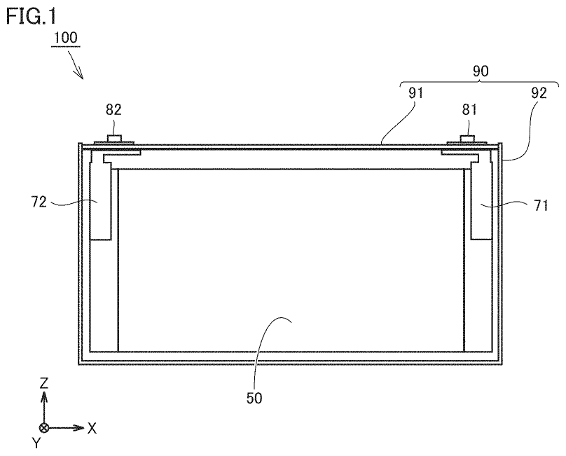

FIG. 1 is a schematic diagram showing an exemplary configuration of a nonaqueous electrolyte secondary battery in the present embodiment.

Battery 100 can be used for any purpose of use. Battery 100 may be used as a main electric power supply or an electric power supply for motive-power assisting in an electrically powered vehicle, for example. A battery module or a battery pack may be formed by connecting a plurality of batteries 100. Battery 100 may have a rated capacity of, for example, 1 to 200 Ah.

Battery 100 includes an exterior package 90. Exterior package 90 has a prismatic shape (shape of flat profile rectangular parallelepiped). It should be noted that the prismatic shape is exemplary. Exterior package 90 may have any shape. Exterior package 90 may have, for example, a cylindrical shape or a pouch shape. Exterior package 90 may be composed of, for example, an aluminum (Al) alloy. Exterior package 90 stores an electrode assembly 50 and an electrolyte solution (not shown). Exterior package 90 may include, for example, a sealing plate 91 and an exterior container 92. Sealing plate 91 closes the opening of exterior container 92. For example, sealing plate 91 may be joined to exterior container 92 by laser welding or the like.

A positive electrode terminal 81 and a negative electrode terminal 82 are provided on sealing plate 91. Sealing plate 91 may be further provided with an injection opening (not shown) and a gas discharge valve (not shown). The electrolyte solution can be injected from the injection opening to inside of exterior package 90. Positive electrode current collecting member 71 connects electrode assembly 50 and positive electrode terminal 81 to each other. Positive electrode current collecting member 71 may be, for example, an Al plate or the like. Negative electrode current collecting member 72 connects electrode assembly 50 and negative electrode terminal 82 to each other. Negative electrode current collecting member 72 may be, for example, a copper (Cu) plate or the like.

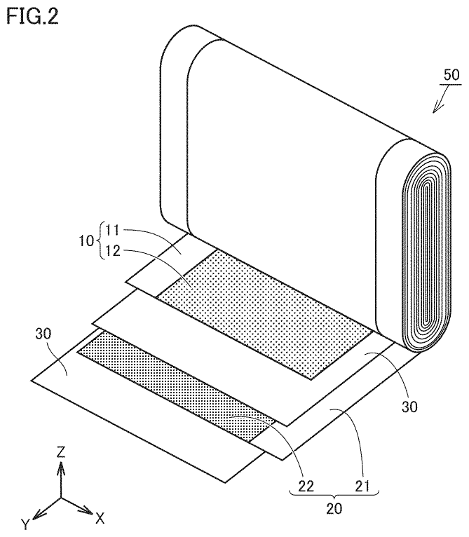

FIG. 2 is a schematic diagram showing an exemplary configuration of an electrode assembly in the present embodiment.

Electrode assembly 50 is of winding type. Electrode assembly 50 includes a positive electrode 10, a separator 30, and a negative electrode 20. That is, battery 100 includes a positive electrode 10, a negative electrode 20, and an electrolyte. Each of positive electrode 10, separator 30, and negative electrode 20 is a sheet in a form of a strip. Electrode assembly 50 may include a plurality of separators 30. Electrode assembly 50 is constructed by: layering positive electrode 10, separator 30, and negative electrode 20 in this order; and winding them in the form of a spiral. One of positive electrode 10 or negative electrode 20 may be interposed between separators 30. Both positive electrode 10 and negative electrode 20 may be interposed between separators 30. Electrode assembly 50 may be shaped to have a flat shape after the winding. It should be noted that the winding type is exemplary. Electrode assembly 50 may be, for example, of a stack type.

<<Positive Electrode>>

Positive electrode 10 includes a positive electrode substrate 11 and a positive electrode active material layer 12. Positive electrode substrate 11 is an electrically conductive sheet. Positive electrode substrate 11 may be, for example, an Al alloy foil or the like. Positive electrode substrate 11 may have a thickness of, for example, 10 to 30 μm. Positive electrode active material layer 12 is disposed on a surface of positive electrode substrate 11. Positive electrode active material layer 12 may be disposed only on one surface of positive electrode substrate 11, for example. Positive electrode active material layer 12 may be disposed on each of the front and rear surfaces of positive electrode substrate 11, for example. Positive electrode substrate 11 may be exposed at one end portion in the width direction of positive electrode 10 (X axis direction in FIG. 2). Positive electrode current collecting member 71 can be joined to the exposed portion of positive electrode substrate 11.

Positive electrode active material layer 12 may have a thickness of 10 to 200 μm, may have a thickness of 50 to 150 μm, or may have a thickness of 50 to 100 μm, for example. Positive electrode active material layer 12 may have an apparent density of 3.5 to 3.8 g/cm³ or may have an apparent density of 3.5 to 3.7 g/cm³, for example. The apparent density of positive electrode active material layer 12 is determined by dividing the mass of positive electrode active material layer 12 by the apparent volume of positive electrode active material layer 12.

For example, an intermediate layer (not shown) may be interposed between positive electrode active material layer 12 and positive electrode substrate 11. The intermediate layer does not include the positive electrode active material. In the present embodiment, also when the intermediate layer is interposed therebetween, positive electrode active material layer 12 is regarded as being disposed on the surface of positive electrode substrate 11. The intermediate layer may be thinner than positive electrode active material layer 12 and positive electrode substrate 11. The intermediate layer may have a thickness of 0.1 to 10 μm, for example. The intermediate layer may include, for example, a conductive material, an insulating material, or the like.

(Multilayer Structure)

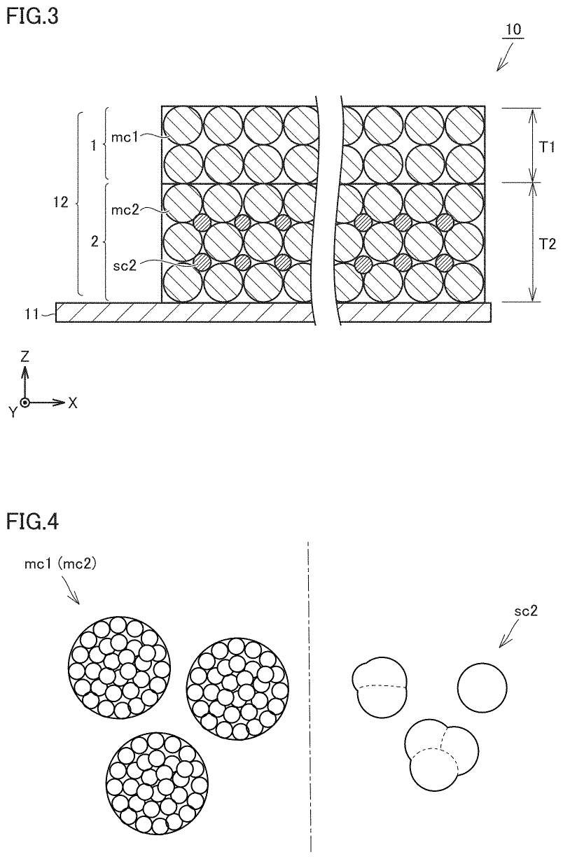

FIG. 3 is a schematic cross sectional view showing an exemplary configuration of the positive electrode in the present embodiment.

Positive electrode active material layer 12 has a multilayer structure. That is, positive electrode active material layer 12 includes a first layer 1 and a second layer 2. Second layer 2 is disposed between positive electrode substrate 11 and first layer 1.

Positive electrode active material layer 12 may include an additional layer (not shown) as long as first layer 1 and second layer 2 are included. The additional layer has a composition different from those of first layer 1 and second layer 2. For example, the additional layer may be formed between first layer 1 and second layer 2. For example, the additional layer may be formed between the surface of positive electrode active material layer 12 and first layer 1. For example, the additional layer may be formed between second layer 2 and positive electrode substrate 11.

(First Layer)

First layer 1 is an upper layer. First layer 1 is disposed on the surface side of positive electrode active material layer 12 with respect to second layer 2. First layer 1 may be exposed at the surface of positive electrode active material layer 12. First layer 1 may form the surface of positive electrode active material layer 12.

First layer 1 includes a first positive electrode active material. For example, first layer 1 may consist essentially of the first positive electrode active material. For example, first layer 1 may further include a conductive material and a binder in addition to the first positive electrode active material. For example, first layer 1 may consist of: 0.1 to 10% of the conductive material in mass fraction; 0.1 to 10% of the binder in mass fraction; and a remainder of the first positive electrode active material.

The first positive electrode active material includes first aggregated particles mc1. By disposing first aggregated particles mc1 in the upper layer, it is expected to reduce an increase in resistivity due to the mixing of single-particles sc2. The first positive electrode active material may consist essentially of first aggregated particles mc1. The first positive electrode active material may further include the single-particles in addition to first aggregated particles mc1. It should be noted that first aggregated particles mc1 can be a main component of the first positive electrode active material. The “main component” in the present embodiment refers to a component having the maximum mass fraction among a plurality of components. In the first positive electrode active material, the mass fraction of first aggregated particles mc1 may be more than or equal to 50%, may be more than or equal to 70%, or may be more than or equal to 90%, for example.

FIG. 4 is a conceptual diagram of the aggregated particles and the single-particles.

First aggregated particles mc1 are secondary particles. First aggregated particles mc1 can also be referred to as “multiple crystals”. Each of first aggregated particles mc1 is formed by aggregation of 50 or more primary particles. For example, first aggregated particle mc1 may include 100 or more primary particles. There is no upper limit for the number of the primary particles. For example, first aggregated particle mc1 may include 10000 or less primary particles. It should be noted that the “number of particles” represents the number of particles appearing in the cross sectional SEM image.

Each of the “primary particles” in the present embodiment is a particle in which no grain boundary can be confirmed in its external appearance in the cross sectional SEM image. The primary particle may have any shape. The primary particle may have a spherical shape, a columnar shape, a lump-like shape, or the like, for example. The primary particles may have an arithmetic mean diameter of less than 0.5 μm, or may have an arithmetic mean diameter of 0.05 to 0.2 μm, for example.

Each of first aggregated particles mc1 may have any shape. First aggregated particle mc1 may have a spherical shape, a columnar shape, a lump-like shape, or the like, for example. First aggregated particles mc1 may have an arithmetic mean diameter larger than the arithmetic mean diameter of single-particles sc2, for example. Thus, it is expected to reduce the resistivity, for example. The arithmetic mean diameter of first aggregated particles mc1 may be 5 to 20 μm or may be 15 to 19 μm, for example.

(Second Layer)

Second layer 2 is a lower layer. Second layer 2 is disposed on the positive electrode substrate 11 side with respect to first layer 1. Second layer 2 may be in direct contact with positive electrode substrate 11. Second layer 2 may be formed on the surface of positive electrode substrate 11.

Second layer 2 includes a second positive electrode active material. For example, second layer 2 may consist essentially of the second positive electrode active material. For example, second layer 2 may further include a conductive material and a binder in addition to the second positive electrode active material. For example, second layer 2 may consist of: 0.1 to 10% of the conductive material in mass fraction; 0.1 to 10% of the binder in mass fraction; and a remainder of the second positive electrode active material.

Second layer 2 includes second aggregated particles mc2 and single-particles sc2. By disposing the mixture of second aggregated particles mc2 and single-particles sc2 in the lower layer, it is expected to improve the packing characteristic. The mixing ratio of second aggregated particles mc2 and single-particles sc2 is arbitrary. For example, the relation of “the second aggregated particles/the single-particles=9/1 to 5/5 (mass ratio)” may be satisfied, or the relation of “the second aggregated particles/the single-particles=9/1 to 7/3 (mass ratio)” may be satisfied.

Each of second aggregated particles mc2 is formed by aggregation of 50 or more primary particles. Details of the primary particles are as described above. Second aggregated particle mc2 may have substantially the same structure, shape, and size as those of first aggregated particle mc1, or may have different structure, shape, and size from those of first aggregated particle mc1, for example. Second aggregated particles mc2 may have an arithmetic mean diameter larger than the arithmetic mean diameter of single-particles sc2. Thus, it is expected to improve the packing characteristic, for example. The arithmetic mean diameter of second aggregated particles mc2 may be 5 to 20 μm or may be 15 to 19 μm, for example.

Single-particles sc2 are independent of second aggregated particles mc2. Each of the “single-particles” in the present embodiment is a particle in which no grain boundary can be confirmed in its external appearance in the cross sectional SEM image. Single-particle sc2 may also be referred to as “single crystal”. One single-particle sc2 may be present solely. Two to ten single-particles sc2 may form an aggregate (see FIG. 4).

Each of single-particles sc2 may have any shape. Single-particle sc2 may have a spherical shape, a columnar shape, a lump-like shape, or the like, for example. Single-particles sc2 are primary particles grown to be relatively large. That is, single-particles sc2 have an arithmetic mean diameter larger than the arithmetic mean diameter of the primary particles included in first aggregated particles mc1 and second aggregated particles mc2. The arithmetic mean diameter of single-particles sc2 may be 0.5 to 10 μm or may be 3.5 to 4.5 μm, for example.

(Thickness Ratio)

First layer 1 and second layer 2 may satisfy, for example, the relation of the following formula (I):

0.2≤T1/(T1+T2)≤0.5 (I).

In the formula (I), “T1” represents the thickness of first layer 1, and “T2” represents the thickness of second layer 2. When the relation of the formula (I) is satisfied, it is expected to improve balance between the packing characteristic and the resistivity, for example. “T1/(T1+T2)” may be less than or equal to 0.3, for example.

First layer 1 and second layer 2 may satisfy, for example, a relation of the following formula (II):

0.5≤T2/(T1+T2)≤0.8 (II).

When the relation of the formula (II) is satisfied, it is expected to improve the balance between the packing characteristic and the resistivity, for example. “T2/(T1+T2)” may be more than or equal to 0.7, for example.

The thickness of each layer is measured in the cross sectional SEM image of positive electrode active material layer 12. The cross sectional SEM image is obtained in a cross section parallel to the thickness direction (Z axis direction in FIG. 3) of positive electrode active material layer 12. The thickness of each layer is measured at five or more positions. The arithmetic mean of the thicknesses at the five or more positions is regarded as the thickness of the layer.

(Chemical Composition)

Each of first aggregated particles mc1, second aggregated particles mc2 and single-particles sc2 can have any chemical composition. First aggregated particles mc1, second aggregated particles mc2 and single-particles sc2 may have chemical compositions different from one another or may have substantially the same chemical composition.

For example, each of first aggregated particles mc1, second aggregated particles mc2, and single-particles sc2 may independently include at least one selected from a group consisting of LiCoO₂, LiNiO₂, LiMnO₂, LiMn₂O₄, Li(NiCoMn)O₂, Li(NiCoAl)O₂, and LiFePO₄. Here, for example, in the composition formula such as “Li(NiCoMn)O₂”, the total of the composition ratios in the parentheses is 1 (Ni+Co+Mn=1). The composition ratio of each element (Ni, Co, Mn) is arbitrary as long as the total of the composition ratios is 1.

For example, each of first aggregated particles mc1, second aggregated particles mc2, and single-particles sc2 may independently have the chemical composition represented by, for example, the following formula (III):

Li₁₋ₐNiₓMe₁ₓO₂ (III).

In the formula (III), “a” satisfies the relation of “−0.3≤a≤0.3”. “x” satisfies the relation of “0.3≤x≤1.0”. “Me” represents at least one selected from a group consisting of cobalt (Co), manganese (Mn), aluminum (Al), zirconium (Zr), boron (B), magnesium (Mg), iron (Fe), copper (Cu), zinc (Zn), tin (Sn), sodium (Na), potassium (K), barium (Ba), strontium (Sr), calcium (Ca), tungsten (W), molybdenum (Mo), niobium (Nb), titanium (Ti), silicon (Si), vanadium (V), chromium (Cr), and germanium (Ge).

For example, each of first aggregated particles mc1, second aggregated particles mc2, and single-particles sc2 may independently have a chemical composition represented by, for example, the following formula (IV):

Li₁₋ₐNiₓCo_{y}Mn_{1-x-y}O₂ (IV).

In the formula (IV), “a” satisfies the relation of “−0.3≤a≤0.3”. “x” satisfies the relation of “0.5≤x≤0.8”. “y” satisfies the relation of “0.2≤y≤0.5”.

(Conductive Material)

Each of first layer 1 and second layer 2 can independently include any conductive material. For example, each of first layer 1 and second layer 2 may independently include at least one selected from a group consisting of acetylene black, carbon nanotube, graphene flake, and graphite.

(Binder)

Each of first layer 1 and second layer 2 can independently include any binder. For example, each of first layer 1 and second layer 2 independently may include at least one selected from a group consisting of polyvinylidene difluoride (PVdF), poly(vinylidene fluoride-co-hexafluoropropylene) (PVdF-HFP), polytetrafluoroethylene (PTFE), and polyacrylic acid (PAA).

<<Negative Electrode>>

Negative electrode 20 may include a negative electrode substrate 21 and a negative electrode active material layer 22, for example. Negative electrode substrate 21 is an electrically conductive sheet. Negative electrode substrate 21 may be, for example, a Cu alloy foil or the like. Negative electrode substrate 21 may have a thickness of, for example, 5 to 30 μm. Negative electrode active material layer 22 may be disposed on a surface of negative electrode substrate 21. Negative electrode active material layer 22 may be disposed only on one surface of negative electrode substrate 21, for example. Negative electrode active material layer 22 may be disposed on each of the front and rear surfaces of negative electrode substrate 21, for example. Negative electrode substrate 21 may be exposed at one end portion in the width direction of negative electrode 20 (X axis direction in FIG. 2). Negative electrode current collecting member 72 can be joined to the exposed portion of negative electrode substrate 21.

Negative electrode active material layer 22 may have a thickness of, for example, 10 to 200 Negative electrode active material layer 22 includes a negative electrode active material. The negative electrode active material can include any component. The negative electrode active material may include, for example, at least one selected from a group consisting of graphite, soft carbon, hard carbon, SiO, Si-based alloy, Si, SnO, Sn-based alloy, Sn, and Li₄Ti₅O₁₂.

Negative electrode active material layer 22 may further include, for example, a binder or the like in addition to the negative electrode active material. For example, negative electrode active material layer 22 may consist essentially of: 0.1 to 10% of the binder in mass fraction; and a remainder of the negative electrode active material. The binder can include any component. The binder may include, for example, at least one selected from a group consisting of carboxymethyl cellulose (CMC) and styrene-butadiene rubber (SBR).

<<Separator>>

At least a portion of separator 30 is interposed between positive electrode 10 and negative electrode 20. Separator 30 separates positive electrode 10 and negative electrode 20 from each other. Separator 30 may have a thickness of, for example, 10 to 30 μm.

Separator 30 is a porous sheet. Separator 30 permits the electrolyte solution to pass therethrough. Separator 30 may have an air permeability of, for example, 100 to 400 s/100 mL. In the present specification, the “air permeability” represents “air resistance” defined in “JIS P 8117: 2009”. The air permeability is measured by the Gurley test method.

Separator 30 is electrically insulative. Separator 30 may include, for example, a polyolefin-based resin or the like. Separator 30 may consist essentially of a polyolefin-based resin, for example. The polyolefin-based resin may include at least one selected from a group consisting of polyethylene (PE) and polypropylene (PP), for example. Separator 30 may have a single-layer structure, for example. Separator 30 may consist essentially of a PE layer, for example. Separator 30 may have a multilayer structure, for example. Separator 30 may be formed by layering a PP layer, a PE layer, and a PP layer in this order, for example. A heat-resistant layer (ceramic particle layer) or the like may be formed on the surface of separator 30, for example.

<<Electrolyte Solution>>

The electrolyte solution is a liquid electrolyte. The electrolyte solution includes a solvent and a supporting electrolyte. The solvent is aprotic. The solvent can include any component. The solvent may include, for example, at least one selected from a group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. For example, the supporting electrolyte may include at least one selected from a group consisting of LiPF₆, LiBF₄, and LiN(FSO₂)₂. The supporting electrolyte may have a molar concentration of 0.5 to 2.0 mol/L, or may have a molar concentration of 0.8 to 1.2 mol/L, for example.

The electrolyte solution may further include any additive in addition to the solvent and the supporting electrolyte. For example, the electrolyte solution may include 0.01 to 5% of the additive in mass fraction. The additive may include, for example, at least one selected from a group consisting of vinylene carbonate (VC), lithium difluorophosphate (LiPO₂F₂), lithium fluorosulfonate (FSO₃Li), and lithium bis[oxalatoborate] (LiBOB).

It should be noted that instead of the electrolyte solution, a gel electrolyte may be used or a solid electrolyte may be used, for example. The solid electrolyte can function also as a separator. That is, a solid electrolyte layer may separate the positive electrode and the negative electrode from each other.

### EXAMPLES

Hereinafter, an example of the present technology (also referred to as “the present example” in the present specification) will be described. However, the scope of the present technology is not restricted by the following description.

<Production of Positive Electrode>

<<No. 1>>

The following materials were prepared.

Aggregated particles: Li(NiCoMn)O₂

Single-particles: Li(NiCoMn)O₂

Conductive material: acetylene black

Binder: PVdF

Dispersion medium: N-methyl-2-pyrrolidone

Positive electrode substrate: Al foil

The aggregated particles were handled as the first positive electrode active material. That is, the first positive electrode active material consists of the aggregated particles. 97.5 parts by mass of the first positive electrode active material, 1 part by mass of the conductive material, 1.5 parts by mass of the binder, and a predetermined amount of the dispersion medium were mixed, thereby preparing a first slurry.

The aggregated particles and the single-particles are mixed, thereby preparing the second positive electrode active material. The mixing ratio was as follows: “the aggregated particles/the single-particles=5/5 (mass ratio)”. 97.5 parts by mass of the second positive electrode active material, 1 part by mass of the conductive material, 1.5 parts by mass of the binder, and a predetermined amount of the dispersion medium were mixed, thereby preparing a second slurry.

A simultaneous multilayer coating apparatus was prepared. The first slurry and the second slurry were substantially simultaneously applied onto the front surface (one surface) of the positive electrode substrate, thereby forming a coating film. The second slurry was discharged between the positive electrode substrate and the first slurry. The coating film was dried to form the positive electrode active material layer. The positive electrode active material layer consisted of the first layer and the second layer. The first layer was formed from the first slurry. The second layer was formed from the second slurry. The second layer was disposed between the positive electrode substrate and the first layer. Similarly, the positive electrode active material layer was also formed on the rear surface of the positive electrode substrate. That is, the positive electrode active material layer was formed on each of the front and rear surfaces of the positive electrode substrate. The positive electrode active material layer was compressed by a rolling machine. Thus, a positive electrode according to No. 1 was produced.

<<No. 2>>

A third slurry was prepared in the same manner as the first slurry with the single-particles being handled as the first positive electrode active material. A positive electrode according to No. 2 was produced in the same manner as the positive electrode according to No. 1 except that the third slurry was used instead of the first slurry.

<<No. 3>>

A positive electrode according to No. 3 was produced in the same manner as the positive electrode according to No. 1 except that the positive electrode active material layer having a single-layer structure was formed using the first slurry.

<<No. 4>>

A positive electrode according to No. 4 was produced in the same manner as the positive electrode according to No. 1 except that the positive electrode active material layer having a single-layer structure was formed using the third slurry.

<<No. 5>>

A positive electrode according to No. 5 was produced in the same manner as the positive electrode according to No. 1 except that the positive electrode active material layer having a single-layer structure was formed using the second slurry.

<Evaluations>

<<Packing Ratio>>

A sample piece of a predetermined size was cut out from each of the positive electrodes. The apparent density of the positive electrode active material layer was determined in accordance with the thickness and mass of the sample piece. In the present example, the apparent density is regarded as the packing ratio.

<<Resistivity>>

The resistivity of the positive electrode active material layer was measured by an electrode resistance measuring instrument.

The measurement results of the packing ratio and the resistivity are shown in Table 1 below. In the present example, when the packing ratio is more than or equal to 3.56 g/cm³ and the resistivity is less than or equal to 28 Ω·cm, both the packing ratio and the resistivity are regarded as being ensured.

<<Others>>

The thickness ratio “T1/(T1+T2)” was also measured in the cross sectional SEM image. The arithmetic mean diameter of the aggregated particles and the arithmetic mean diameter of the single-particles were also measured in the cross sectional SEM image. The aggregated particles had an arithmetic mean diameter larger than the arithmetic mean diameter of the single-particles.

TABLE 1

| | Positive Electrode Active Material Layer | | | Evaluations | |
|---|---|---|---|---|---|
| | | Thickness Ratio | | | Packing |
| | | T1/(T1 + T2) | Positive Electrode | Resistivity | Ratio |
| No. | Structure | [—] | Active Material | [Ω · cm] | [g/cm³] |
| 1 | First Layer | 0.25 | Aggregated Particles | 27.8 | 3.58 |
| | (Upper Layer) | | | | |
| | Second Layer | | Aggregated Particles + | | |
| | (Lower Layer) | | Single-Particles | | |
| 2 | First Layer | 0.25 | Single-Particles | 36.7 | 3.63 |
| | (Upper Layer) | | | | |
| | Second Layer | | Aggregated Particles + | | |
| | (Lower Layer) | | Single-Particles | | |
| 3 | Single-Layer | | Aggregated Particles | 45.2 | 3.54 |
| | Structure | | | | |
| 4 | Single-Layer | | Single-Particles | 89.8 | 3.68 |
| | Structure | | | | |
| 5 | Single-Layer | | Aggregated Particles + | 29.2 | 3.60 |
| | Structure | | Single-Particles | | |

<Results>

In the positive electrode according to No. 1, both the packing ratio and the resistivity were ensured. In the positive electrode according to No. 1, the aggregated particles are disposed in first layer 1 (upper layer), and the mixture of the aggregated particles and the single-particles is disposed in the second layer (lower layer).

The positive electrode according to No. 2 had a high resistivity. In the positive electrode according to No. 2, the single-particles are disposed in first layer 1 (upper layer).

The positive electrode according to No. 3 had a high resistivity. In the positive electrode according to No. 3, the positive electrode active material layer has a single-layer structure. The single-layer structure consists of the aggregated particles. It is considered that since the packing characteristic of the positive electrode active material layer is poor, contact resistance becomes large to result in the increased resistivity.

The positive electrode according to No. 4 had a high resistivity. In the positive electrode according to No. 4, the positive electrode active material layer has a single-layer structure. The single-layer structure consists of the single-particles. It is considered that since the single-particles have the high resistivity, the resistivity of the positive electrode active material layer is increased.

The positive electrode according to No. 5 had a high resistivity. In the positive electrode according to No. 5, the positive electrode active material layer has a single-layer structure. The single-layer structure consists of the mixture (uniform phase) of the aggregated particles and the single-particles.

The present embodiment and the present example are illustrative in any respects. The present embodiment and the present examples are not restrictive. The scope of the present technology includes any modifications within the scope and meaning equivalent to the terms of the claims. For example, it is initially expected to extract freely configurations from the present embodiment and the present example and combine them freely.

What is claimed is:

1. A positive electrode for a nonaqueous electrolyte secondary battery, the positive electrode comprising:
a positive electrode substrate; and
a positive electrode active material layer, wherein
the positive electrode active material layer is disposed on a surface of the positive electrode substrate,
the positive electrode active material layer includes a first layer and a second layer,
the second layer is disposed between the positive electrode substrate and the first layer,
the first layer includes a first positive electrode active material,
the first positive electrode active material includes first aggregated particles,
the second layer includes a second positive electrode active material,
the second positive electrode active material includes second aggregated particles and single-particles,
each of the first aggregated particles and the second aggregated particles is formed by aggregation of 50 or more primary particles, and
the single-particles have an arithmetic mean diameter larger than an arithmetic mean diameter of the primary particles.

2. The positive electrode according to claim 1, wherein the first aggregated particles have an arithmetic mean diameter larger than the arithmetic mean diameter of the single-particles, and the second aggregated particles have an arithmetic mean diameter larger than the arithmetic mean diameter of the single-particles.

3. The positive electrode according to claim 1, wherein
a relation of the following formula (I) is satisfied:
0.2≤T1/(T1+T2)≤0.5 (I), where
T1 represents a thickness of the first layer, and T2 represents a thickness of the second layer.

4. A nonaqueous electrolyte secondary battery comprising the positive electrode according to claim 1.
